(19) United States
(12) Patent Application Publication
(10) Pub. No.: US 2025/0266638 A1
(43) Pub. Date: Aug. 21, 2025

(54) ELECTRICAL CONNECTOR

(71) Applicant: CHENG UEI PRECISION INDUSTRY CO., LTD., New Taipei City (TW)

(72) Inventors: CHENG-WANG YANG, Dong-Guan City (CN); YAN SUN, Dong-Guan City (CN)

(21) Appl. No.: 18/889,358

(22) Filed: Sep. 18, 2024

(30) Foreign Application Priority Data
Feb. 21, 2024 (CN) 202420325379.2

(51) Int. Cl. H01R 13/502; H01R 13/02; H01R 13/652; H01R 13/6581

(52) U.S. Cl. CPC H01R 13/502; H01R 13/02; H01R 13/652; H01R 13/6581

(57) ABSTRACT

An electrical connector includes an insulation body, a terminal assembly and a middle grounding plate. The insulation body has a base body and two internal spaces. A front end of the base body extends frontward to form a stepping portion. Two sides of a front end of the stepping portion extend frontward and then extend towards each other to form a docking portion. The docking portion includes a docking end and two connecting arms. The docking end is connected to two front ends of the two connecting arms. The terminal assembly is fastened in the insulation body. The middle grounding plate is mounted in a middle of the terminal assembly. The middle grounding plate has two bending arms. The two bending arms are disposed to two opposite sides of the docking portion through the two internal spaces.

### CROSS REFERENCE TO RELATED APPLICATIONS

The present application is based on, and claims priority from, China Patent Application No. 202420325379.2, filed Feb. 21, 2024, the disclosure of which is hereby incorporated by reference herein in its entirety.

### BACKGROUND OF THE INVENTION

### Field of the Invention

The present invention generally relates to an electrical connector, and more particularly to an electrical connector having a better structure strength.

### Description of Related Art

In various electrical connector types which are frequently used by various electronic products, universal serial bus (USB) connectors are the most widely applied connectors. With the improvement of sciences and technologies, more and more kinds of the universal serial bus connectors are developed, such as USB 2.0 connectors, USB 3.0 connectors, Micro USB connectors, Mini USB connectors or USB Type-C connectors. The USB Type-C connectors have been widely applied in the various electronic products.

A conventional electrical connector includes an insulation body, a plurality of upper terminals, a plurality of lower terminals, a middle grounding plate and a shielding shell. The conventional electrical connector is a reliable Type-C receptacle connector. The insulation body has an upper insulation body, a lower insulation body and an outer insulation body. The plurality of the upper terminals are fastened to the upper insulation body by an injection molding technology. The plurality of the upper terminals include a plurality of upper power terminals and a plurality of upper grounding terminals. The plurality of the lower terminals are fastened to the lower insulation body by the injection molding technology. The plurality of the lower terminals include a plurality of lower power terminals and a plurality of lower grounding terminals. The middle grounding plate is disposed between the upper insulation body and the lower insulation body. The middle grounding plate, the plurality of the upper terminals, the upper insulation body, the plurality of the lower terminals and the lower insulation body are fastened in the outer insulation body by the injection molding technology.

However, when the conventional electrical connector is inserted into or withdrawn from a docking connector, because the insulation body and the middle grounding plate of the conventional electrical connector have insufficient structure strengths, so the conventional electrical connector easily sways along a transverse direction, and the insulation body which is made of a plastic material, the plurality of the upper terminals and the plurality of the lower terminals of the conventional electrical connector are easily pulled to be broken and deformed. As a result, a damage phenomenon of the conventional electrical connector is caused to be happened.

Thus, it is essential to provide an innovative electrical connector having a better structure strength.

### BRIEF SUMMARY OF THE INVENTION

An object of the present invention is to provide an electrical connector having a better structure strength. The electrical connector includes an insulation body, a terminal assembly and a middle grounding plate. The insulation body has a base body and two internal spaces. A front end of the base body extends frontward to form a stepping portion. The stepping portion is a hollow structure. Two sides of a front end of the stepping portion extend frontward and then extend towards each other to form a docking portion. The docking portion has a docking end and two connecting arms. Two inner surfaces of two opposite sides of the stepping portion extend inward to form two protruding blocks. Two front surfaces of the two protruding blocks extend frontward to form the two connecting arms. The two connecting arms extend out of the front end of the stepping portion. The docking end is connected to two front ends of the two connecting arms. The two connecting arms are connected between the two protruding blocks and two opposite sides of the docking end. The two connecting arms are separated from two side walls of the stepping portion. Each internal space is formed among an outer surface of one connecting arm, an outer surface of one protruding block and an inner surface of one side wall of the stepping portion which are adjacent. The terminal assembly is fastened in the insulation body. The terminal assembly has a base block, and a plurality of terminals fastened in the base block. Two opposite sides of a front end of the base block are recessed inward to form two inserting spaces. The two connecting arms are disposed in the two inserting spaces. The middle grounding plate is mounted in a middle of the terminal assembly. The middle grounding plate has a base plate and two bending arms. Two middles of two opposite sides of the base plate protrude outward, then are bent upward, later extend frontward, next are curved outward and are further bent rearward to form the two bending arms, respectively. The base plate is mounted in the base block. The two bending arms are disposed to two opposite sides of the docking portion through the two internal spaces. The two bending arms are connected to two outer portions of two opposite sides of the two connecting arms.

Another object of the present invention is to provide an electrical connector. The electrical connector includes an insulation body, a terminal assembly and a middle grounding plate. The insulation body has a base body and two internal spaces. A front end of the base body extends frontward to form a stepping portion. The stepping portion has a top wall, a bottom wall and two side walls. Two sides of a front end of the stepping portion extend frontward and then extend towards each other to form a docking portion. Two inner surfaces of the two side walls of the stepping portion extend inward to form two protruding blocks. The two protruding blocks keep a distance from the top wall of the stepping portion. The two protruding blocks keep a distance from the bottom wall of the stepping portion. The docking portion has a docking end and two connecting arms. Two front surfaces of the two protruding blocks extend frontward to form the two connecting arms. The docking end is connected to two front ends of the two connecting arms. The two connecting arms keep distances from the two side walls of the stepping portion. The two connecting arms extend out of the front end of the stepping portion. The two connecting arms are connected between two opposite sides of the stepping portion and two opposite sides of the docking end of the docking portion. One end of each connecting arm is connected with a front surface of one protruding block. The other end of each connecting arm is connected with a rear surface of one side of the docking end of the docking portion. Each internal space is formed among an outer surface of one connecting arm, an outer surface of the one protruding block and an inner surface of one side wall of the stepping portion which are adjacent. The terminal assembly is fastened in the insulation body. The terminal assembly has a plurality of terminals and two base portions. The plurality of the terminals are fastened in the two base portions. Each base portion has a main body, a connecting portion and a tongue portion. The main body is disposed in the base body. A front end of the main body extends frontward to form the connecting portion. The connecting portion is disposed in the stepping portion. A front end of the connecting portion extends frontward to form the tongue portion. The tongue portion is disposed between the stepping portion and the docking end of the docking portion. Two opposite sides of an inner surface of the tongue portion protrude inward to form two restricting portions. The two connecting arms are disposed to outer surfaces of the restricting portions of the two base portions of the terminal assembly. Two opposite sides of two front ends of the two tongue portions of the two base portions of the terminal assembly are recessed inward to form two inserting spaces. The two connecting arms are disposed in the two inserting spaces. The middle grounding plate is mounted in a middle of the terminal assembly. The middle grounding plate is disposed among the restricting portions of the two tongue portions of the two base portions of the terminal assembly. The middle grounding plate has a base plate and two bending arms. Two middles of two opposite sides of the base plate protrude outward, then are bent upward, later extend frontward, next are curved outward and are further bent rearward to form the two bending arms, respectively. The base plate is mounted between the two base portions. The two bending arms are disposed in the two internal spaces. The two bending arms are connected to two outer portions of two opposite sides of the two connecting arms.

Another object of the present invention is to provide an electrical connector. The electrical connector includes an insulation body, a terminal assembly and a middle grounding plate. The insulation body has a base body and two internal spaces. A front end of the base body extends frontward to form a stepping portion. The stepping portion has a top wall, a bottom wall and two side walls. Two sides of a front end of the stepping portion extend frontward and then extend towards each other to form a docking portion. Two inner surfaces of the two side walls of the stepping portion extend inward to form two protruding blocks. The two protruding blocks keep a distance from the top wall of the stepping portion. The two protruding blocks keep a distance from the bottom wall of the stepping portion. The docking portion has a docking end and two connecting arms. Two front surfaces of the two protruding blocks extend frontward to form the two connecting arms. The docking end is connected to two front ends of the two connecting arms. The two connecting arms keep distances from the two side walls of the stepping portion. The two connecting arms extend out of the front end of the stepping portion. The two connecting arms are connected between two opposite sides of the stepping portion and two opposite sides of the docking end of the docking portion. One end of each connecting arm is connected with a front surface of one protruding block. The other end of each connecting arm is connected with a rear surface of one side of the docking end of the docking portion. Each connecting arm has a main portion. One end of the main portion is connected with the one protruding block of the stepping portion, and the other end of the main portion is connected with the docking end of the docking portion. An outer surface of the main portion extends outward to form a protruding portion. Each internal space is formed among an outer surface of one connecting arm, an outer surface of the one protruding block and an inner surface of one side wall of the stepping portion which are adjacent. The terminal assembly is fastened in the insulation body. The terminal assembly has a plurality of terminals and two base portions. The plurality of the terminals are fastened in the two base portions. Each base portion has a main body, a connecting portion and a tongue portion. The main body is disposed in the base body. A front end of the main body extends frontward to form the connecting portion. The connecting portion is disposed in the stepping portion. A front end of the connecting portion extends frontward to form the tongue portion. The tongue portion is disposed between the stepping portion and the docking end of the docking portion. Two opposite sides of an inner surface of the tongue portion protrude inward to form two restricting portions. The two connecting arms are disposed to outer surfaces of the restricting portions of the two base portions of the terminal assembly. Outer side surfaces of two rear ends of the two tongue portions of the two base portions are flush with two outer surfaces of two rear ends of the two protruding portions of the two connecting arms of the insulation body. Two opposite sides of two front ends of the two tongue portions of the two base portions of the terminal assembly are recessed inward to form two inserting spaces. The two connecting arms are disposed in the two inserting spaces. The middle grounding plate is mounted in a middle of the terminal assembly. The middle grounding plate is disposed among the restricting portions of the two tongue portions of the two base portions of the terminal assembly. The middle grounding plate has a base plate and two bending arms. Two middles of two opposite sides of the base plate protrude outward, then are bent upward, later extend frontward, next are curved outward and are further bent rearward to form the two bending arms, respectively. A front of each bending arm is curved outward and then is bent rearward to form a hook portion. The base plate is mounted between the two base portions. The two bending arms are disposed in the two internal spaces. The two bending arms are connected to two outer portions of two opposite sides of the two connecting arms. Two front ends of the two hook portions of the two bending arms are surrounded by the two opposite sides of the docking end of the docking portion of the insulation body.

As described above, the two connecting arms are disposed between the two opposite sides of the stepping portion and the two opposite sides of docking portion to reinforce a structure strength of the insulation body by an innovative structure of the electrical connector. The two inserting spaces are formed among the bottom surface of the tongue portion of an upper terminal assembly, the top surface of the tongue portion of a lower terminal assembly and the outer surfaces of the restricting portions of the terminal assembly. The two connecting arms are disposed in the two inserting spaces. Two bending portions and two rear ends of two extending arms of the two bending arms are surrounded by the stepping portion of the insulation body. The two hook portions are partially surrounded by the two opposite sides of the docking portion of the insulation body to reinforce a structure strength of the electrical connector. As a result, the electrical connector has the better structure strength.

### BRIEF DESCRIPTION OF THE DRAWINGS

The present invention will be apparent to those skilled in the art by reading the following description, with reference to the attached drawings, in which:

FIG. 1 is a perspective view of an electrical connector in accordance with the present invention;

FIG. 2 is a partially exploded view showing a glue body, an insulating housing, a metal shell assembly, and an insulation body together with a terminal assembly, a middle grounding plate and two shielding plates of the electrical connector of FIG. 1;

FIG. 3 is another partially exploded view showing the insulation body, the two shielding plates, and the terminal assembly together with the middle grounding plate of the electrical connector of FIG. 2;

FIG. 4 is a perspective view of the insulation body of the electrical connector of FIG. 2;

FIG. 5 is an exploded view of an upper terminal assembly of the terminal assembly of the electrical connector of FIG. 2;

FIG. 6 is another exploded view of the upper terminal assembly of the terminal assembly of the electrical connector of FIG. 5;

FIG. 7 is a perspective view of a middle grounding plate of the electrical connector of FIG. 2;

FIG. 8 is a diagrammatic drawing of the electrical connector of FIG. 1; and

FIG. 9 is a sectional view of the electrical connector along a line IX-IX of FIG. 8.

### DETAILED DESCRIPTION OF THE INVENTION

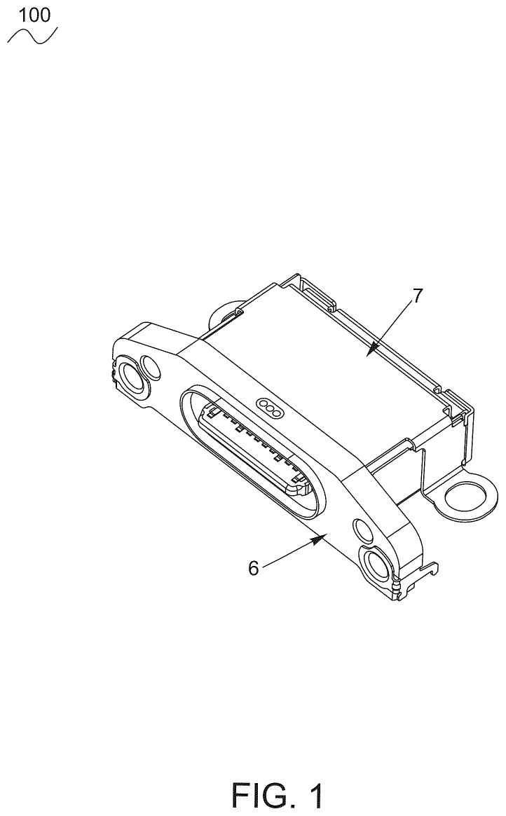

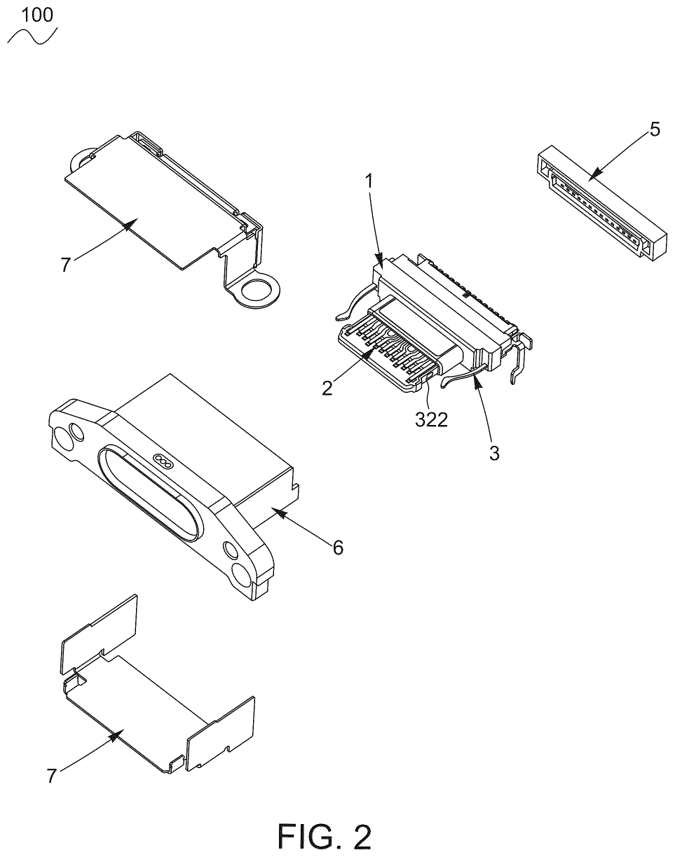

With reference to FIG. 1 to FIG. 3, an electrical connector 100 in accordance with the present invention is shown. The electrical connector 100 includes an insulation body 1, a terminal assembly 2, a middle grounding plate 3, two shielding plates 4, a glue body 5, an insulating housing 6 and a metal shell assembly 7. In the present invention, the electrical connector 100 is a USB (Universal Serial Bus) Type-C connector. In a concrete implementation, the electrical connector 100 is able to be another type connector which is different from the USB Type-C connector.

The terminal assembly 2 is fastened in the insulation body 1. The middle grounding plate 3 is mounted in a middle of the terminal assembly 2, and the terminal assembly 2 and the middle grounding plate 3 are fastened in the insulation body 1. The insulation body 1 surrounds the middle grounding plate 3 and the terminal assembly 2. The two shielding plates 4 are disposed to an upper surface and a lower surface of the insulation body 1. The insulation body 1, the terminal assembly 2, the middle grounding plate 3, the two shielding plates 4 and the glue body 5 are fastened in the insulating housing 6. The metal shell assembly 7 is fastened to a top surface and a bottom surface of the insulating housing 6. The metal shell assembly 7 is used for being connected to ground and shielding an interference.

The glue body 5 surrounds a rear end of the insulation body 1. The glue body 5 surrounds a part of the terminal assembly 2 and a part of the middle grounding plate 3. The glue body 5 covers to a rear end of the insulating housing 6. The glue body 5 seals up an interval which is formed among the insulation body 1, the terminal assembly 2, the middle grounding plate 3 and the insulating housing 6, so that water is prevented from flowing into a rear end of the electrical connector 100, and the electrical connector 100 is prevented from being damaged due to a water infiltration of the electrical connector 100.

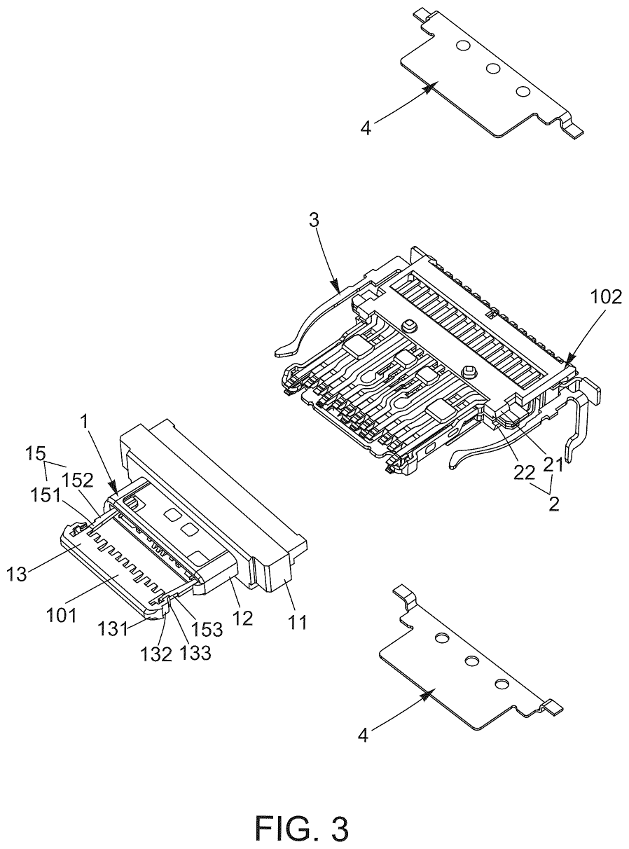

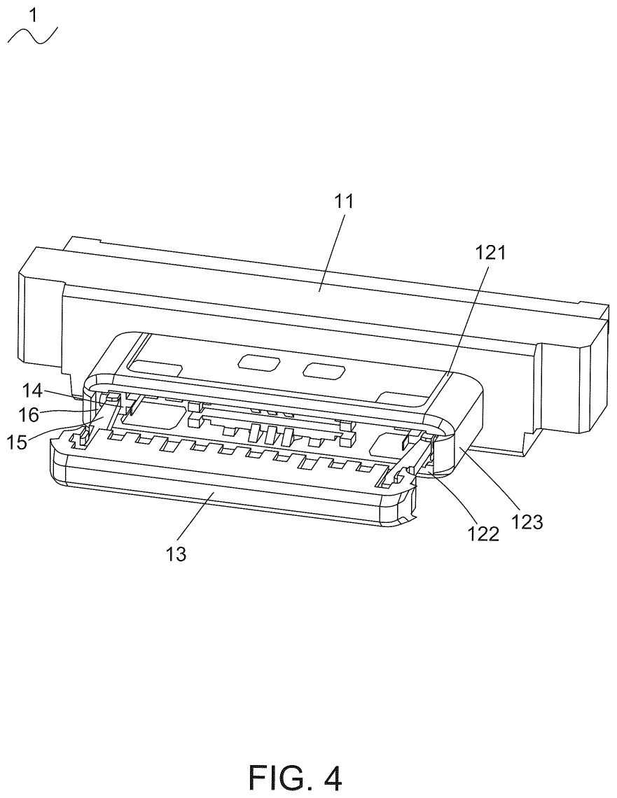

Referring to FIG. 3 and FIG. 4, the insulation body 1 has a base body 11, a stepping portion 12, a docking portion 13, two protruding blocks 14 and two internal spaces 16. A middle of a front end of the base body 11 extends frontward to form the stepping portion 12. The stepping portion 12 is a hollow structure. Two middles of two sides of a front end of the stepping portion 12 extend frontward and then extend towards each other to form the docking portion 13. The docking portion 13 is a lying U shape. The mouth of the docking portion 13 faces towards a middle of the front end of the stepping portion 12. A front end of the docking portion 13 surrounds a front end of the terminal assembly 2. Two inner surfaces of the two opposite sides of the stepping portion 12 extend inward to form the two protruding blocks 14. The stepping portion 12 has a top wall 121, a bottom wall 122 and two side walls 123. Two inner surfaces of the two side walls 123 of the stepping portion 12 extend inward to form the two protruding blocks 14. The two protruding blocks 14 are separated from the top wall 121 and the bottom wall 122 of the stepping portion 12. The two protruding blocks 14 keep a distance from the top wall 121 of the stepping portion 12. The two protruding blocks 14 keep a distance from the bottom wall 122 of the stepping portion 12. The two protruding blocks 14 are fastened in corresponding mechanisms of the middle grounding plate 3 to realize that the insulation body 1 is located to the middle grounding plate 3, and the insulation body 1 is fixed to the middle grounding plate 3.

The docking portion 13 includes a docking end 101 and two connecting arms 15. Two front surfaces of the two protruding blocks 14 extend frontward to form the two connecting arms 15. The front end of the docking portion 13 is defined as the docking end 101. The two connecting arms 15 are defined as two sides of the docking portion 13. The two connecting arms 15 extend out of the front end of the stepping portion 12. The docking end 101 is connected to two front ends of the two connecting arms 15. The two connecting arms 15 are connected between the two protruding blocks 14 and two opposite sides of the docking end 101. The two connecting arms 15 are connected between the two opposite sides of the stepping portion 12 and the two opposite sides of the docking end 101 of the docking portion 13. The two connecting arms 15 are disposed between the two opposite sides of the stepping portion 12 and two opposite sides of the front end of the docking portion 13. One end of each connecting arm 15 is connected with a front surface of one protruding block 14 of the stepping portion 12. The other end of each connecting arm 15 is connected with a rear surface of one side of the front end of the docking portion 13. The other end of each connecting arm 15 is connected with a rear surface of one side of the docking end 101 of the docking portion 13. The two connecting arms 15 are separated from the two side walls 123 of the stepping portion 12. The two connecting arms 15 keep distances from the two side walls 123 of the stepping portion 12. Each internal space 16 is formed among an outer surface of one connecting arm 15, an outer surface of one protruding block 14 and the inner surface of one side wall 123 of the stepping portion 12 which are adjacent. Two corresponding sections of the middle grounding plate 3 are disposed to two outer portions of two opposite sides of the docking portion 13 through the two internal spaces 16 of the insulation body 1. The two corresponding sections of the middle grounding plate 3 are disposed to two outer portions of two opposite sides of the two connecting arm 15 through the two internal spaces 16 of the insulation body 1.

The front end of the docking portion 13 has two enclosing portions 131, two locating surfaces 132 and two arc portions 133, so the docking end 101 has the two enclosing portions 131, the two locating surfaces 132 and the two arc portions 133. The two opposite sides of the docking end 101 have the two enclosing portions 131, the two locating surfaces 132 and the two arc portions 133. Two fronts of the two opposite sides of the docking end 101 protrude outward to form the two enclosing portions 131. The two enclosing portions 131 surround two corresponding areas of the middle grounding plate 3 to realize that the insulation body 1 is located to the middle grounding plate 3, and the insulation body 1 is fixed to the middle grounding plate 3. Two middles of the two opposite sides of the docking end 101 are recessed inward to form the two locating surfaces 132 located to two rear ends of the two enclosing portions 131. Two corresponding segments of the middle grounding plate 3 are disposed to the two locating surfaces 132 to realize that the insulation body 1 is located to the middle grounding plate 3, and the insulation body 1 is fixed to the middle grounding plate 3.

Two rears of the two opposite sides of the docking end 101 are concaved inward to form the two arc portions 133 located to two rear ends of the two locating surfaces 132. The two arc portions 133 are disposed to two outer surfaces of the two front ends of the two connecting arms 15. Two corresponding regions of the middle grounding plate 3 are disposed to the two arc portions 133 to realize that the insulation body 1 is located to the middle grounding plate 3, and the insulation body 1 is fixed to the middle grounding plate 3. The docking end 101 which is the front end of the docking portion 13 surrounds the front end of the terminal assembly 2 and a front end of the middle grounding plate 3 to reinforce a structure strength of the electrical connector 100.

Each connecting arm 15 has a main portion 151, a protruding portion 152 and a first lacking groove 153. One end of the main portion 151 of each connecting arm 15 is connected with the one protruding block 14 of the stepping portion 12 of the insulation body 1, and the other end of the main portion 151 of each connecting arm 15 is connected with the docking end 101 of the docking portion 13 to reinforce a structure strength of the insulation body 1. An outer surface of the main portion 151 extends outward to form the protruding portion 152. A front end of the protruding portion 152 is recessed inward to form the first lacking groove 153. The first lacking groove 153 is formed between the front end of the protruding portion 152 and a front end of the main portion 151. The first lacking groove 153 is disposed between a rear end of the protruding portion 152 and one arc portion 133 of the docking portion 13. The two first lacking grooves 153 of the insulation body 1 are filled by two corresponding positions of the terminal assembly 2, so that the terminal assembly 2 is located to the insulation body 1, and the terminal assembly 2 is fixed to the insulation body 1. Correspondingly, the structure strength of the electrical connector 100 is reinforced.

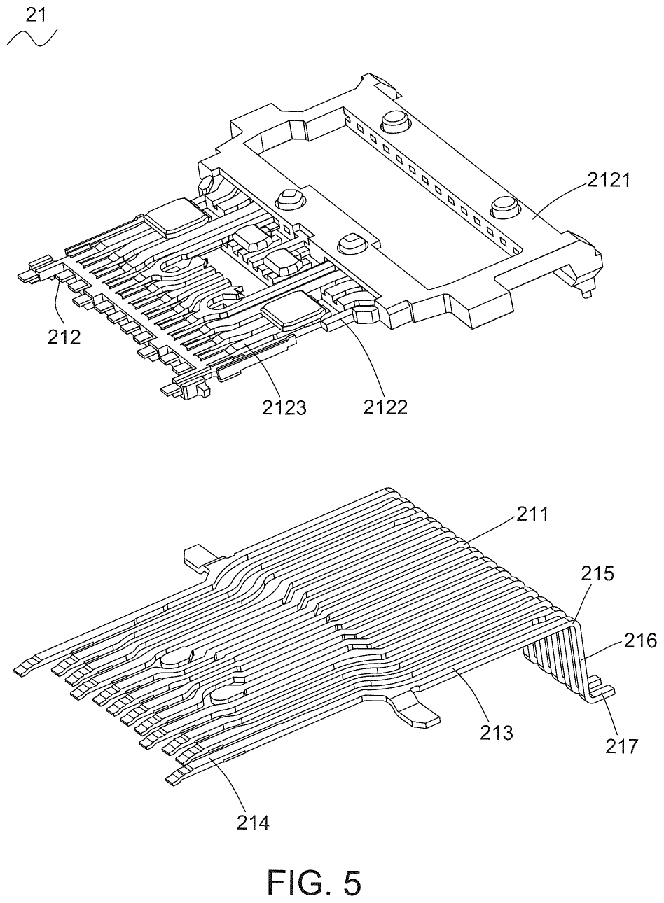

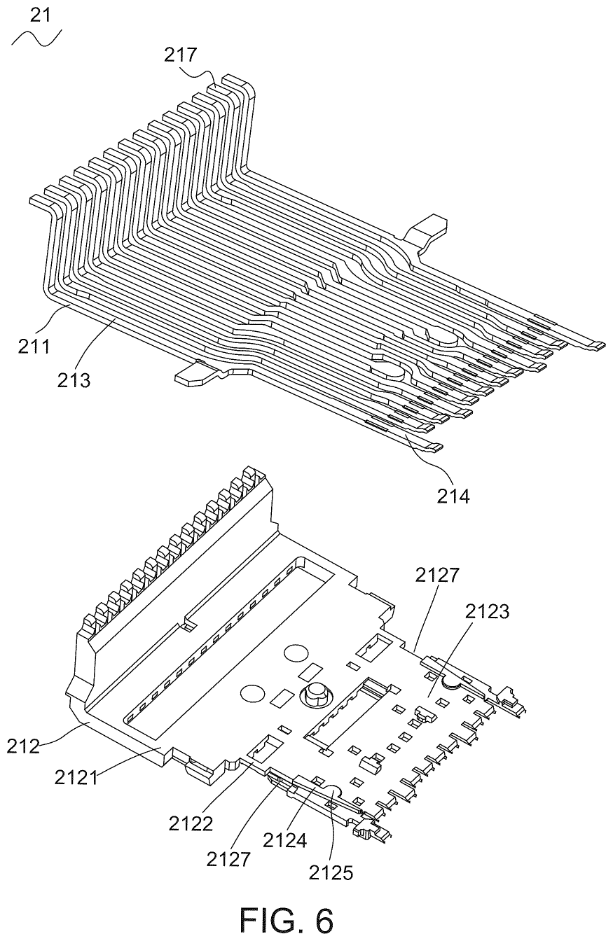

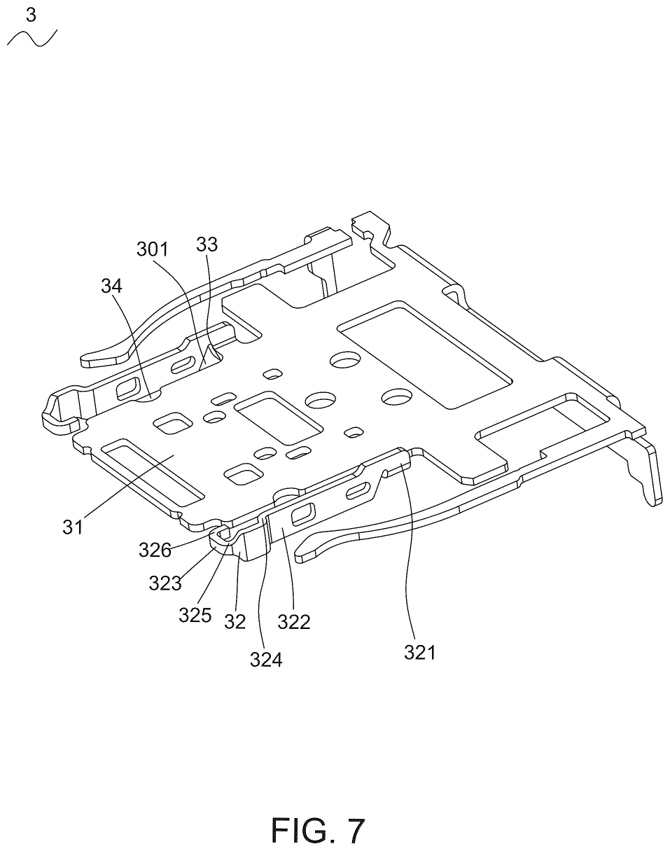

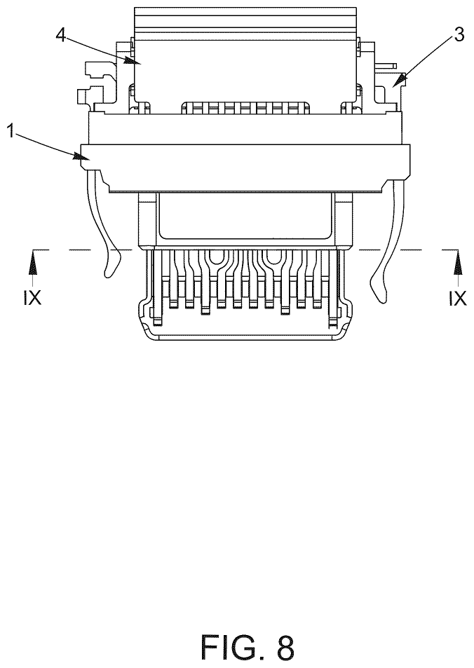

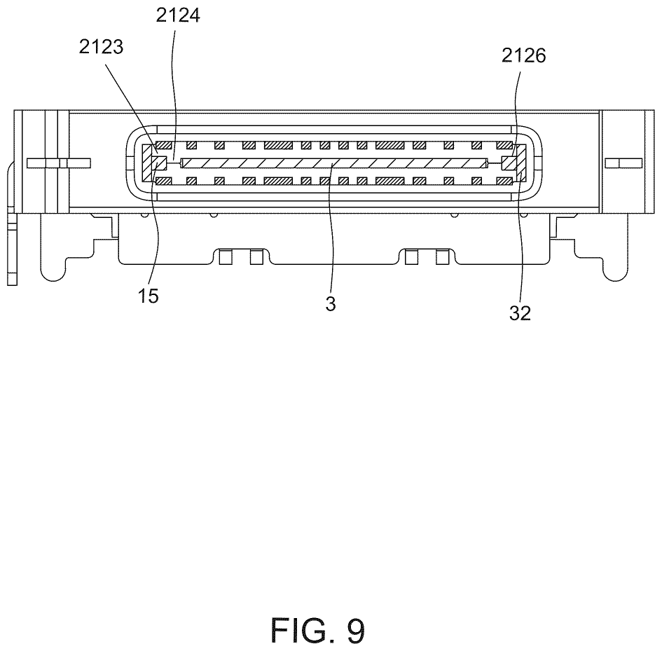

Referring to FIG. 3 to FIG. 9, the terminal assembly 2 is disposed in the insulation body 1. The terminal assembly 2 includes an upper terminal assembly 21 fastened in an upper portion of the insulation body 1, and a lower terminal assembly 22 fastened in a lower portion of the insulation body 1. The upper terminal assembly 21 is disposed on a top surface of the middle grounding plate 3. The lower terminal assembly 22 is disposed under a bottom surface of the middle grounding plate 3. The middle grounding plate 3 is disposed between the upper terminal assembly 21 and the lower terminal assembly 22. The upper terminal assembly 21 includes a plurality of terminals 211 and a base portion 212. The lower terminal assembly 22 includes the plurality of the terminals 211 and the base portion 212. The plurality of the terminals 211 are fastened in the base portion 212.

The terminal assembly 2 includes a base block 102, and the plurality of the terminals 211 fastened in the base block 102. The base block 102 includes two base portions 212 which are the base portion 212 of the upper terminal assembly 21, and the base portion 212 of the lower terminal assembly 22 mounted under the base portion 212 of the upper terminal assembly 21. The terminals 211 of the terminal assembly 2 include the terminals of the upper terminal assembly 21 and the terminals 211 of the lower terminal assembly 22. The terminal assembly 2 includes the plurality of the terminals 211 and the two base portions 212. The plurality of the terminals 211 are fastened in the two base portions 212. The middle grounding plate 3 is mounted in a middle of the base block 102. Each base portion 212 has a main body 2121, a connecting portion 2122 and a tongue portion 2123. Two outer sides of two outermost terminals 211 of the upper terminal assembly 21 are disposed to two top surfaces of two main portions 151 of the two connecting arms 15 of the insulation body 1. Two outer sides of two outermost terminals 211 of the lower terminal assembly 22 are disposed to two bottom surfaces of the two main portions 151 of the two connecting arms 15 of the insulation body 1.

Each terminal 211 has a fastening portion 213, a contacting portion 214, a bending piece 215, an extending portion 216 and a soldering portion 217. A front end of the fastening portion 213 extends frontward to form the contacting portion 214. A rear end of the fastening portion 213 is bent downward to form the bending piece 215. A bottom end of the bending piece 215 extends downward to form the extending portion 216. A bottom end of the extending portion 216 is bent rearward to form the soldering portion 217.

The base portion 212 has the main body 2121, the connecting portion 2122 and the tongue portion 2123. The main body 2121 is disposed in the base body 11 of the insulation body 1. A middle of a front end of the main body 2121 extends frontward to form the connecting portion 2122. The connecting portion 2122 is disposed in the stepping portion 12 of the insulation body 1. A front end of the connecting portion 2122 extends frontward to form the tongue portion 2123. The tongue portion 2123 is disposed between the stepping portion 12 and the docking end 101 of the docking portion 13 of the insulation body 1. Outer side surfaces of two rear ends of the two tongue portions 2123 of the two base portions 212 of the terminal assembly 2 are flush with two outer surfaces of two rear ends of the two protruding portions 152 of the two connecting arms 15 of the insulation body 1.

The two first lacking grooves 153 of the two connecting arms 15 of the insulation body 1 are filled by the tongue portion 2123, so that the terminal assembly 2 is located to the insulation body 1, and the terminal assembly 2 is fixed to the insulation body 1. The docking end 101 of the docking portion 13 of the insulation body 1 surrounds a front end of the tongue portion 2123 of the base portion 212. The fastening portions 213 of the plurality of the terminals 211 are fastened in the main body 2121 and the connecting portion 2122 of the base portion 212, and the fastening portions 213 of the plurality of the terminals 211 are surrounded by the main body 2121 and the connecting portion 2122 of the base portion 212. The contacting portions 214 of the plurality of the terminals 211 are fastened in the tongue portion 2123 of the base portion 212, and the contacting portions 214 of the plurality of the terminals 211 are partially surrounded by the tongue portion 2123 of the base portion 212. The soldering portions 217 of the plurality of the terminals 211 project beyond a rear surface and a bottom surface of the main body 2121 of the base portion 212.

Two opposite sides of a bottom surface of the tongue portion 2123 of the upper terminal assembly 21 extend downward to form two restricting portions 2124. Two opposite sides of a top surface of the tongue portion 2123 of the lower terminal assembly 22 extend upward to form the two restricting portions 2124. The two opposite sides of the top surface of one tongue portion 2123 and the two opposite sides of the bottom surface of the other tongue portion 2123 of the terminal assembly 2 extend inward to form a plurality of the restricting portions 2124. Two opposite sides of an inner surface of the tongue portion 2123 of each base portion 212 protrude inward to form two restricting portions 2124. An outer side of each restricting portion 2124 keeps a distance from an outer side of the tongue portion 2123. An upper portion of the middle grounding plate 3 is disposed between the two restricting portions 2124 of the tongue portion 2123 of the upper terminal assembly 21. A lower portion of the middle grounding plate 3 is disposed between the two restricting portions 2124 of the tongue portion 2123 of the lower terminal assembly 22. The middle grounding plate 3 is disposed among the restricting portions 2124 of the two tongue portions 2123 of the two base portions 212 of the terminal assembly 2. The two connecting arms 15 of the insulation body 1 are disposed to outer surfaces of the plurality of the restricting portions 2124 of the two base portions 212 of the terminal assembly 2. The two connecting arms 15 of the insulation body 1 are connected to the outer surfaces of the plurality of the restricting portions 2124 of the terminal assembly 2.

When the electrical connector 100 is assembled, the upper terminal assembly 21, the lower terminal assembly 22 and the middle grounding plate 3 are assembled together. The two restricting portions 2124 of the upper terminal assembly 21 are mounted on the two restricting portions 2124 of the lower terminal assembly 22. Two inserting spaces 2126 are formed among the outer surfaces of the restricting portions 2124 of the terminal assembly 2, a bottom surface of the base portion 212 of the upper terminal assembly 21 and a top surface of the base portion 212 of the lower terminal assembly 22. Two inserting spaces 2126 are formed among the outer surfaces of the restricting portions 2124 of the terminal assembly 2, the bottom surface of the tongue portion 2123 of the upper terminal assembly 21 and the top surface of the tongue portion 2123 of the lower terminal assembly 22. The two connecting arms 15 of the insulation body 1 are inserted into the two inserting spaces 2126. Two opposite sides of two front ends of the two tongue portions 2123 of the two base portions 212 of the terminal assembly 2 are recessed inward to form the two inserting spaces 2126. Two opposite sides of a front end of the base block 102 are recessed inward to form the two inserting spaces 2126.

Two middles of two inner surfaces of the two restricting portions 2124 of each tongue portion 2123 protrude inward to form two fastening blocks 2125. The two fastening blocks 2125 are fastened in corresponding locations of the middle grounding plate 3 to realize that the terminal assembly 2 is located to the middle grounding plate 3, and the terminal assembly 2 is fixed to the middle grounding plate 3.

Two rear ends of two opposite sides of each tongue portion 2123 are recessed inward to form two second lacking grooves 2127. The second lacking grooves 2127 of the terminal assembly 2 are disposed behind the restricting portions 2124 of the terminal assembly 2. The two protruding blocks 14 of the stepping portion 12 of the insulation body 1 are limited in the second lacking grooves 2127 of the terminal assembly 2. A lot of configurations of the lower terminal assembly 22 and the upper terminal assembly 21 are roughly the same, and the lower terminal assembly 22 and the upper terminal assembly 21 are without being described in detail.

Referring to FIG. 1 to FIG. 7, the middle grounding plate 3 has a base plate 31, two bending arms 32, two first location portions 33 and two second location portions 34. The base plate 31 is mounted in the middle of the base block 102. The base plate 31 is mounted between the two base portions 212. Two middles of two opposite sides of the base plate 31 protrude outward, then are bent upward, later extend frontward, next are curved outward and are further bent rearward to form the two bending arms 32, respectively. Rear ends of the two bending arms 32 are surrounded by the stepping portion 12 of the insulation body 1. The two bending arms 32 are disposed in the two internal spaces 16. The two bending arms 32 are disposed to the two opposite sides of the docking portion 13 of the insulation body 1 through the two internal spaces 16 of the insulation body 1. The two bending arms 32 are disposed to the two outer portions of the two opposite sides of the two connecting arms 15 through the two internal spaces 16 of the insulation body 1. The two bending arms 32 are connected to the two outer portions of the two opposite sides of the two connecting arms 15 through the two internal spaces 16 of the insulation body 1.

A front and a middle of each bending arm 32 are spaced from a front of one side of the base plate 31 to form a clamping groove 301 between the front and the middle of the bending arm 32 and the one side of the base plate 31. A junction between each bending arm 32 and the base plate 31 is recessed inward to form the first location portion 33. The two protruding blocks 14 of the stepping portion 12 of the insulation body 1 are clamped in the two clamping grooves 301 of the middle grounding plate 3. The two protruding blocks 14 are blocked by the two first location portions 33 of the two bending arms 32 and the base plate 31 to realize that the insulation body 1 is located to the middle grounding plate 3, and the insulation body 1 is fixed to the middle grounding plate 3. The two fronts of the two opposite sides of the base plate 31 are recessed inward to form the two second location portions 34. The two second location portions 34 are disposed in front of the two first location portions 33. The fastening blocks 2125 of the two base portions 212 of the terminal assembly 2 are fastened in the two second location portions 34 to realize that the terminal assembly 2 is located to the middle grounding plate 3, and the terminal assembly 2 is fixed to the middle grounding plate 3.

Two inner surfaces of the two bending arms 32 are connected with the outer surfaces of the two connecting arms 15 and the two protruding blocks 14 of the insulation body 1. Each bending arm 32 has a bending portion 321, an extending arm 322 and a hook portion 323. The front of each bending arm 32 is curved outward and then is bent rearward to form the hook portion 323. The bending portion 321 is protruded outward and is perpendicularly bent upward from the middle of the one side of the base plate 31. A front end of the bending portion 321 slantwise extends frontward and downward, and then extends frontward to form the extending arm 322. A front end of the extending arm 322 is arched outward, then is bent inward and is further bent rearward to form the hook portion 323.

The two bending portions 321 and two rear ends of the two extending arms 322 of the two bending arms 32 are surrounded by the stepping portion 12 of the insulation body 1. The two bending portions 321 and the two rear ends of the two extending arms 322 of the two bending arms 32 are disposed in the two internal spaces 16 of the insulation body 1. The bending portion 321 and the rear end of the extending arm 322 of each bending arm 32 are disposed among the outer surface of the one connecting arm 15 and the outer surface of the one protruding block 14, and the inner surface of the one side wall 123 of the stepping portion 12 which are adjacent. The front ends and two middles of the two extending arms 322 are disposed to two outer surfaces of the two connecting arms 15 of the insulation body 1. The front ends and two middles of the two extending arms 322 are disposed to two outer surfaces of the two protruding portions 152 of the two connecting arms 15 of the insulation body 1 and outer surfaces of the two tongue portions 2123 of the two base portions 212 of the terminal assembly 2. The two hook portions 323 of the two bending arms 32 are partially surrounded by the two opposite sides of the docking end 101 of the docking portion 13 of the insulation body 1 to reinforce the structure strength of the electrical connector 100. Two front ends of the two hook portions 323 of the two bending arms 32 are surrounded by the two opposite sides of the docking end 101 of the docking portion 13 of the insulation body 1.

Each hook portion 323 has a first bending section 324, a second bending section 325 and a third bending section 326. The first bending section 324 is arched outward from the front end of the extending arm 322. The first bending sections 324 of the two hook portions 323 of the two bending arms 32 are partially mounted to the two arc portions 133 of the docking portion 13 of the insulation body 1 to realize that the middle grounding plate 3 is located to the insulation body 1, and the middle grounding plate 3 is fixed to the insulation body 1. The second bending section 325 is bent inward and towards the base plate 31 of the middle grounding plate 3 from a front end of the first bending section 324. The third bending section 326 is bent rearward from a free end of the second bending section 325. The third bending section 326 is bent rearward from an inner end of the second bending section 325. The first bending section 324, the second bending section 325 and the third bending section 326 reinforce the structure strength of the middle grounding plate 3 so as to reinforce the structure strength of the electrical connector 100.

The first bending sections 324 of the two hook portions 323 of the two bending arms 32 are disposed at the two locating surfaces 132 and the two arc portions 133 of the docking portion 13 of the insulation body 1 to realize that the middle grounding plate 3 is located to the insulation body 1, and the middle grounding plate 3 is fixed to the insulation body 1. The second bending sections 325 and the third bending sections 326 of the two bending arms 32 are surrounded by the two enclosing portions 131 of the docking portion 13 of the insulation body 1 to realize that the middle grounding plate 3 is located to the insulation body 1, and the middle grounding plate 3 is fixed to the insulation body 1.

The two bending portions 321 of the two bending arms 32 are received in the insulation body 1. The two extending arms 322 of the two bending arms 32 are partially received in the insulation body 1. The two front ends of the two extending arms 322 and the two first bending sections 324 of the two bending arms 32 are exposed to two sides of the insulation body 1. The two second bending sections 325 and the two third bending sections 326 of the two bending arms 32 are fastened in the docking portion 13 of the insulation body 1 to reinforce the structure strength of the electrical connector 100, correspondingly, the middle grounding plate 3 is located to the insulation body 1, and the middle grounding plate 3 is fixed to the insulation body 1.

The first bending section 324, the second bending section 325 and the third bending section 326 together form the hook portion 323 for reinforcing the structure strength of the middle grounding plate 3 of the electrical connector 100 so as to enhance the structure strength of the electrical connector 100. The bending portion 321, the extending arm 322 and the hook portion 323 form the bending arm 32. Each bending arm 32 is protruded outward and is perpendicularly extended upward.

The two connecting arms 15 are disposed between the two opposite sides of the stepping portion 12 and the two opposite sides of the docking end 101 of the docking portion 13 to reinforce the structure strength of the insulation body 1. The outer surfaces of the two tongue portions 2123 of the two base portions 212 of the terminal assembly 2 are flush with the two outer surfaces of the two protruding portions 152 of the two connecting arms 15 of the insulation body 1. The two bending arms 32 are disposed to two outsides of the two protruding portions 152 of the two connecting arms 15 of the insulation body 1. The two protruding portions 152 of the two connecting arms 15 of the insulation body 1 are disposed among the two bending arms 32 of the middle grounding plate 3, the two tongue portions 2123 and the two restricting portions 2124 of the terminal assembly 2.

With reference to FIG. 1 to FIG. 9, when the electrical connector 100 is assembled, at first, one base portion 212 is molded with the plurality of the terminals 211 by an injection molding process to form the upper terminal assembly 21, and the other base portion 212 is molded with the plurality of the terminals 211 by the injection molding process to form the lower terminal assembly 22. The upper terminal assembly 21, the lower terminal assembly 22 and the middle grounding plate 3 are manufactured in advance. Then the upper terminal assembly 21, the lower terminal assembly 22 and the middle grounding plate 3 are assembled together, so that the middle grounding plate 3 is positioned between the upper terminal assembly 21 and the lower terminal assembly 22. Then the two inserting spaces 2126 are formed among the bottom surface of the tongue portion 2123 of the upper terminal assembly 21, the top surface of the tongue portion 2123 of the lower terminal assembly 22 and the outer surfaces of the restricting portions 2124 of the terminal assembly 2. Finally, the insulation body 1 is molded outside the upper terminal assembly 21, the lower terminal assembly 22 and the middle grounding plate 3 by the injection molding process. The two connecting arms 15 of the insulation body 1 are disposed in the two inserting spaces 2126 of the terminal assembly 2.

The base body 11 and the stepping portion 12 of the insulation body 1 are formed at a rear end of the terminal assembly 2 and a rear end of the middle grounding plate 3. The docking portion 13 of the insulation body 1 is formed at the front end of the terminal assembly 2 and the front end of the middle grounding plate 3. The stepping portion 12 of the insulation body 1 is integrally molded with the docking end 101 of the docking portion 13 of the insulation body 1 by the two connecting arms 15 of the insulation body 1, so that molding times of the injection molding process are reduced.

As described above, the two connecting arms 15 are disposed between the two opposite sides of the stepping portion 12 and the two opposite sides of docking portion 13 to reinforce the structure strength of the insulation body 1 by an innovative structure of the electrical connector 100. The two inserting spaces 2126 are formed among the bottom surface of the tongue portion 2123 of the upper terminal assembly 21, the top surface of the tongue portion 2123 of the lower terminal assembly 22 and the outer surfaces of the restricting portions 2124 of the terminal assembly 2. The two connecting arms 15 are disposed in the two inserting spaces 2126. The two bending portions 321 and the two rear ends of the two extending arms 322 of the two bending arms 32 are surrounded by the stepping portion 12 of the insulation body 1. The two hook portions 323 are partially surrounded by the two opposite sides of the docking portion 13 of the insulation body 1 to reinforce the structure strength of the electrical connector 100. As a result, the electrical connector 100 has the better structure strength.

What is claimed is:

1. An electrical connector, comprising:
an insulation body having a base body and two internal spaces, a front end of the base body extending frontward to form a stepping portion, the stepping portion being a hollow structure, two sides of a front end of the stepping portion extending frontward and then extending towards each other to form a docking portion, the docking portion having a docking end and two connecting arms, two inner surfaces of two opposite sides of the stepping portion extending inward to form two protruding blocks, two front surfaces of the two protruding blocks extending frontward to form the two connecting arms, the two connecting arms extending out of the front end of the stepping portion, the docking end being connected to two front ends of the two connecting arms, the two connecting arms being connected between the two protruding blocks and two opposite sides of the docking end, the two connecting arms being separated from two side walls of the stepping portion, each internal space being formed among an outer surface of one connecting arm, an outer surface of one protruding block and an inner surface of one side wall of the stepping portion which are adjacent;
a terminal assembly fastened in the insulation body, the terminal assembly having a base block, and a plurality of terminals fastened in the base block, two opposite sides of a front end of the base block being recessed inward to form two inserting spaces, the two connecting arms being disposed in the two inserting spaces; and
a middle grounding plate mounted in a middle of the terminal assembly, the middle grounding plate having a base plate and two bending arms, two middles of two opposite sides of the base plate protruding outward, then being bent upward, later extending frontward, next being curved outward and being further bent rearward to form the two bending arms, respectively, the base plate being mounted in the base block, the two bending arms being disposed to two opposite sides of the docking portion through the two internal spaces, the two bending arms being connected to two outer portions of two opposite sides of the two connecting arms.

2. The electrical connector as claimed in claim 1, wherein each bending arm has a bending portion, an extending arm and a hook portion, the bending portion is protruded outward and is perpendicularly bent upward from a middle of one side of the base plate, a front end of the bending portion slantwise extends frontward and downward, and then extends frontward to form the extending arm, a front end of the extending arm is arched outward, then is bent inward and is further bent rearward to form the hook portion, the two bending portions and two rear ends of the two extending arms of the two bending arms are surrounded by the stepping portion of the insulation body, the front ends and two middles of the two extending arms are disposed to two outer surfaces of the two connecting arms of the insulation body, the two hook portions of the two bending arms are partially surrounded by the two opposite sides of the docking end of the docking portion of the insulation body, the two bending portions and the two rear ends of the two extending arms of the two bending arms are disposed in the two internal spaces of the insulation body.

3. The electrical connector as claimed in claim 2, wherein each connecting arm has a main portion, one end of the main portion is connected with the one protruding block of the stepping portion, and the other end of the main portion is connected with the docking end of the docking portion, an outer surface of the main portion extends outward to form a protruding portion, the front ends and the two middles of the two extending arms are disposed to two outer surfaces of the two protruding portions of the two connecting arms of the insulation body.

4. The electrical connector as claimed in claim 3, wherein two opposite sides of the docking end have two enclosing portions, two locating surfaces and two arc portions, two fronts of the two opposite sides of the docking end protrude outward to form the two enclosing portions, two middles of the two opposite sides of the docking end are recessed inward to form the two locating surfaces located to two rear ends of the two enclosing portions, two rears of the two opposite sides of the docking end are concaved inward to form the two arc portions located to two rear ends of the two locating surfaces, the two arc portions are disposed to two outer surfaces of the two front ends of the two connecting arms, a front end of the protruding portion is recessed inward to form a first lacking groove, the first lacking groove is formed between the front end of the protruding portion and the main portion, the first lacking groove is disposed between a rear end of the protruding portion and one arc portion.

5. The electrical connector as claimed in claim 4, wherein the terminal assembly includes an upper terminal assembly fastened in an upper portion of the insulation body, and a lower terminal assembly fastened in a lower portion of the insulation body, the middle grounding plate is disposed between the upper terminal assembly and the lower terminal assembly, the upper terminal assembly includes the plurality of the terminals and a base portion, the lower terminal assembly includes the plurality of the terminals and the base portion, the base block includes the base portion of the upper terminal assembly, and the base portion of the lower terminal assembly mounted under the base portion of the upper terminal assembly, the terminals of the terminal assembly include the terminals of the upper terminal assembly and the terminals of the lower terminal assembly, two outer sides of two outermost terminals of the upper terminal assembly are disposed to two top surfaces of two main portions of the two connecting arms of the insulation body, two outer sides of two outermost terminals of the lower terminal assembly are disposed to two bottom surfaces of the two main portions of the two connecting arms of the insulation body.

6. The electrical connector as claimed in claim 5, wherein the base portion has a main body, a connecting portion and a tongue portion, the main body is disposed in the base body of the insulation body, a front end of the main body extends frontward to form the connecting portion, the connecting portion is disposed in the stepping portion of the insulation body, a front end of the connecting portion extends frontward to form the tongue portion, the tongue portion is disposed between the stepping portion and the docking end of the docking portion of the insulation body, outer side surfaces of two rear ends of the two tongue portions of the two base portions of the terminal assembly are flush with two outer surfaces of two rear ends of the two protruding portions of the two connecting arms of the insulation body, the two first lacking grooves of the insulation body are filled by the tongue portion, the docking end of the docking portion surrounds a front end of the tongue portion.

7. The electrical connector as claimed in claim 6, wherein two opposite sides of a bottom surface of the tongue portion of the upper terminal assembly extend downward to form two restricting portions, two opposite sides of a top surface of the tongue portion of the lower terminal assembly extend upward to form the two restricting portions, two inserting spaces are formed among outer surfaces of the restricting portions of the terminal assembly, the bottom surface of the tongue portion of the upper terminal assembly and the top surface of the tongue portion of the lower terminal assembly, the two connecting arms are inserted into the two inserting spaces.

8. The electrical connector as claimed in claim 7, wherein a front and a middle of each bending arm are spaced from a front of the one side of the base plate to form a clamping groove between the front and the middle of the bending arm and the one side of the base plate, two middles of two inner surfaces of the two restricting portions of each tongue portion protrude inward to form two fastening blocks, a junction between each bending arm and the base plate is recessed inward to form a first location portion, the two protruding blocks are clamped in the two clamping grooves of the middle grounding plate, the two protruding blocks are blocked by the two first location portions of the two bending arms and the base plate, two fronts of two opposite sides of the base plate are recessed inward to form two second location portions, the two second location portions are disposed in front of the two first location portions, the fastening blocks of the two base portions of the terminal assembly are fastened in the two second location portions.

9. The electrical connector as claimed in claim 7, wherein two rear ends of two opposite sides of each tongue portion are recessed inward to form two second lacking grooves, the second lacking grooves of the terminal assembly are disposed behind the restricting portions of the terminal assembly, the two protruding blocks of the insulation body are limited in the second lacking grooves of the terminal assembly.

10. The electrical connector as claimed in claim 4, wherein each hook portion has a first bending section, a second bending section and a third bending section, the first bending section is arched outward from the front end of the extending arm, the first bending sections of the two hook portions of the two bending arms are partially mounted to the two arc portions of the docking portion of the insulation body, the second bending section is bent inward and towards the base plate of the middle grounding plate from a front end of the first bending section, the third bending section is bent rearward from a free end of the second bending section, the second bending sections and the third bending sections of the two bending arms are surrounded by the two enclosing portions of the docking portion of the insulation body.

11. The electrical connector as claimed in claim 2, wherein the stepping portion has a top wall, a bottom wall and the two side walls, two inner surfaces of the two side walls of the stepping portion extend inward to form the two protruding blocks, the two protruding blocks keep a distance from the top wall of the stepping portion, the two protruding blocks keep a distance from the bottom wall of the stepping portion, the two connecting arms keep distances from the two side walls of the stepping portion.

12. The electrical connector as claimed in claim 1, wherein the docking portion is a lying U shape, the mouth of the docking portion faces towards a middle of the front end of the stepping portion.

13. An electrical connector, comprising:
an insulation body having a base body and two internal spaces, a front end of the base body extending frontward to form a stepping portion, the stepping portion having a top wall, a bottom wall and two side walls, two sides of a front end of the stepping portion extending frontward and then extending towards each other to form a docking portion, two inner surfaces of the two side walls of the stepping portion extending inward to form two protruding blocks, the two protruding blocks keeping a distance from the top wall of the stepping portion, the two protruding blocks keeping a distance from the bottom wall of the stepping portion, the docking portion having a docking end and two connecting arms, two front surfaces of the two protruding blocks extending frontward to form the two connecting arms, the docking end being connected to two front ends of the two connecting arms, the two connecting arms keeping distances from the two side walls of the stepping portion, the two connecting arms extending out of the front end of the stepping portion, the two connecting arms being connected between two opposite sides of the stepping portion and two opposite sides of the docking end of the docking portion, one end of each connecting arm being connected with a front surface of one protruding block, the other end of each connecting arm being connected with a rear surface of one side of the docking end of the docking portion, each internal space being formed among an outer surface of one connecting arm, an outer surface of the one protruding block and an inner surface of one side wall of the stepping portion which are adjacent;
a terminal assembly fastened in the insulation body, the terminal assembly having a plurality of terminals and two base portions, the plurality of the terminals being fastened in the two base portions, each base portion having a main body, a connecting portion and a tongue portion, the main body being disposed in the base body, a front end of the main body extending frontward to form the connecting portion, the connecting portion being disposed in the stepping portion, a front end of the connecting portion extending frontward to form the tongue portion, the tongue portion being disposed between the stepping portion and the docking end of the docking portion, two opposite sides of an inner surface of the tongue portion protruding inward to form two restricting portions, the two connecting arms being disposed to outer surfaces of the restricting portions of the two base portions of the terminal assembly, two opposite sides of two front ends of the two tongue portions of the two base portions of the terminal assembly being recessed inward to form two inserting spaces, the two connecting arms being disposed in the two inserting spaces; and
a middle grounding plate mounted in a middle of the terminal assembly, the middle grounding plate being disposed among the restricting portions of the two tongue portions of the two base portions of the terminal assembly, the middle grounding plate having a base plate and two bending arms, two middles of two opposite sides of the base plate protruding outward, then being bent upward, later extending frontward, next being curved outward and being further bent rearward to form the two bending arms, respectively, the base plate being mounted between the two base portions, the two bending arms being disposed in the two internal spaces, the two bending arms being connected to two outer portions of two opposite sides of the two connecting arms.

14. The electrical connector as claimed in claim 13, wherein a front and a middle of each bending arm are spaced from a front of one side of the base plate to form a clamping groove between the front and the middle of the bending arm and the one side of the base plate, two middles of two inner surfaces of the two restricting portions of each tongue portion protrude inward to form two fastening blocks, a junction between each bending arm and the base plate is recessed inward to form a first location portion, the two protruding blocks are clamped in the two clamping grooves of the middle grounding plate, the two protruding blocks are blocked by the two first location portions of the two bending arms and the base plate, two fronts of two opposite sides of the base plate are recessed inward to form two second location portions, the two second location portions are disposed in front of the two first location portions, the fastening blocks of the two base portions of the terminal assembly are fastened in the two second location portions.

15. The electrical connector as claimed in claim 13, wherein each connecting arm has a main portion, one end of the main portion is connected with the one protruding block of the stepping portion, and the other end of the main portion is connected with the docking end of the docking portion, an outer surface of the main portion extends outward to form a protruding portion, a front end of the protruding portion is recessed inward to form a first lacking groove, the first lacking groove is formed between the front end of the protruding portion and the main portion.

16. The electrical connector as claimed in claim 15, wherein two opposite sides of the docking end have two enclosing portions, two locating surfaces and two arc portions, two fronts of the two opposite sides of the docking end protrude outward to form the two enclosing portions, two middles of the two opposite sides of the docking end are recessed inward to form the two locating surfaces located to two rear ends of the two enclosing portions, two rears of the two opposite sides of the docking end are concaved inward to form the two arc portions located to two rear ends of the two locating surfaces, the two arc portions are disposed to two outer surfaces of the two front ends of the two connecting arms, the first lacking groove is disposed between a rear end of the protruding portion and one arc portion.

17. The electrical connector as claimed in claim 16, wherein each bending arm has a bending portion, an extending arm and a hook portion, the bending portion is protruded outward and is perpendicularly bent upward from a middle of one side of the base plate, a front end of the bending portion slantwise extends frontward and downward, and then extends frontward to form the extending arm, a front end of the extending arm is arched outward, then is bent inward and is further bent rearward to form the hook portion, the two bending portions and two rear ends of the two extending arms of the two bending arms are surrounded by the stepping portion of the insulation body, the front ends and two middles of the two extending arms are disposed to two outer surfaces of the two connecting arms of the insulation body, the two hook portions of the two bending arms are partially surrounded by two opposite sides of the docking end of the docking portion of the insulation body, the two bending portions and the two rear ends of the two extending arms of the two bending arms are disposed in the two internal spaces of the insulation body.

18. The electrical connector as claimed in claim 17, wherein each hook portion has a first bending section, a second bending section and a third bending section, the first bending section is arched outward from the front end of the extending arm, the first bending sections of the two hook portions of the two bending arms are partially mounted to the two arc portions of the docking portion of the insulation body, the second bending section is bent inward and towards the base plate of the middle grounding plate from a front end of the first bending section, the third bending section is bent rearward from a free end of the second bending section, the second bending sections and the third bending sections of the two bending arms are surrounded by the two enclosing portions of the docking portion of the insulation body.

19. An electrical connector, comprising:
an insulation body having a base body and two internal spaces, a front end of the base body extending frontward to form a stepping portion, the stepping portion having a top wall, a bottom wall and two side walls, two sides of a front end of the stepping portion extending frontward and then extending towards each other to form a docking portion, two inner surfaces of the two side walls of the stepping portion extending inward to form two protruding blocks, the two protruding blocks keeping a distance from the top wall of the stepping portion, the two protruding blocks keeping a distance from the bottom wall of the stepping portion, the docking portion having a docking end and two connecting arms, two front surfaces of the two protruding blocks extending frontward to form the two connecting arms, the docking end being connected to two front ends of the two connecting arms, the two connecting arms keeping distances from the two side walls of the stepping portion, the two connecting arms extending out of the front end of the stepping portion, the two connecting arms being connected between two opposite sides of the stepping portion and two opposite sides of the docking end of the docking portion, one end of each connecting arm being connected with a front surface of one protruding block, the other end of each connecting arm being connected with a rear surface of one side of the docking end of the docking portion, each connecting arm having a main portion, one end of the main portion being connected with the one protruding block of the stepping portion, and the other end of the main portion being connected with the docking end of the docking portion, an outer surface of the main portion extending outward to form a protruding portion, each internal space being formed among an outer surface of one connecting arm, an outer surface of the one protruding block and an inner surface of one side wall of the stepping portion which are adjacent;
a terminal assembly fastened in the insulation body, the terminal assembly having a plurality of terminals and two base portions, the plurality of the terminals being fastened in the two base portions, each base portion having a main body, a connecting portion and a tongue portion, the main body being disposed in the base body, a front end of the main body extending frontward to form the connecting portion, the connecting portion being disposed in the stepping portion, a front end of the connecting portion extending frontward to form the tongue portion, the tongue portion being disposed between the stepping portion and the docking end of the docking portion, two opposite sides of an inner surface of the tongue portion protruding inward to form two restricting portions, the two connecting arms being disposed to outer surfaces of the restricting portions of the two base portions of the terminal assembly, outer side surfaces of two rear ends of the two tongue portions of the two base portions being flush with two outer surfaces of two rear ends of the two protruding portions of the two connecting arms of the insulation body, two opposite sides of two front ends of the two tongue portions of the two base portions of the terminal assembly being recessed inward to form two inserting spaces, the two connecting arms being disposed in the two inserting spaces; and
a middle grounding plate mounted in a middle of the terminal assembly, the middle grounding plate being disposed among the restricting portions of the two tongue portions of the two base portions of the terminal assembly, the middle grounding plate having a base plate and two bending arms, two middles of two opposite sides of the base plate protruding outward, then being bent upward, later extending frontward, next being curved outward and being further bent rearward to form the two bending arms, respectively, a front of each bending arm being curved outward and then being bent rearward to form a hook portion, the base plate being mounted between the two base portions, the two bending arms being disposed in the two internal spaces, the two bending arms being connected to two outer portions of two opposite sides of the two connecting arms, two front ends of the two hook portions of the two bending arms being surrounded by the two opposite sides of the docking end of the docking portion of the insulation body.

20. The electrical connector as claimed in claim 19, wherein the terminal assembly has an upper terminal assembly fastened in an upper portion of the insulation body, and a lower terminal assembly fastened in a lower portion of the insulation body, the middle grounding plate is disposed between the upper terminal assembly and the lower terminal assembly, the upper terminal assembly includes the plurality of the terminals and the base portion, the lower terminal assembly includes the plurality of the terminals and the base portion, two outer sides of two outermost terminals of the upper terminal assembly are disposed to two top surfaces of two main portions of the two connecting arms of the insulation body, two outer sides of two outermost terminals of the lower terminal assembly are disposed to two bottom surfaces of the two main portions of the two connecting arms of the insulation body.
